(19) United States
(12) Patent Application Publication
(10) Pub. No.: US 2024/0421854 A1
(43) Pub. Date: Dec. 19, 2024

(54) DEVICE AND OPERATION METHOD FOR OPERATING REFLECTING INTELLIGENT SURFACE IN WIRELESS COMMUNICATION SYSTEM

(71) Applicant: SAMSUNG ELECTRONICS CO., LTD., Suwon-si, Gyeonggi-do (KR)

(72) Inventors: Jungi JEONG, Suwon-si (KR); Junhwa OH, Suwon-si (KR); Sanghyuk WI, Suwon-si (KR); Seungyoon LEE, Suwon-si (KR); Yuntae PARK, Suwon-si (KR)

(21) Appl. No.: 18/704,019

(22) PCT Filed: Oct. 21, 2022
(86) PCT No.: PCT/KR2022/016156

§ 371 Date: Apr. 23, 2024

(30) Foreign Application Priority Data
Oct. 25, 2021 (KR) 10-2021-0143040

(51) Int. Cl. H04B 5/43; H01Q 1/24; H01Q 3/44; H04B 7/04; H04W 16/28; H04W 88/10

(52) U.S. Cl. CPC H04B 5/43; H01Q 1/246; H01Q 3/44; H04B 7/04013; H04W 16/28; H04W 88/10

(57) ABSTRACT

Provided is a 5G or 6G communication system for supporting higher data rates after the 4G communication system such as LTE.

According to the disclosure, a base station (BS) including a near field reflecting intelligent surface (RIS) may include the near field RIS including at least one meta surface which reflects an RIS beam into a target area, a transceiver and a processor. The processor may be configured to identify an operation mode among a normal mode or an RIS mode based on whether a target area is included in a reflecting beam coverage, and control the transceiver to transmit the RIS beam onto the meta surface based on at least one of a type of the near field RIS, configuration information of the near field RIS or information about the target area, in response to the operation mode being identified as the RIS mode.

### TECHNICAL FIELD

The disclosure relates to a device and operation method for operating a reflecting intelligent surface in a wireless communication system, and more particularly, to a base station, to which a near field reflecting intelligent surface is coupled, and a method of operating the base station.

### BACKGROUND ART

Looking back through successive generations at a process of development of radio communication, technologies for human-targeted services such as voice, multimedia, data or the like have been developed. Connected devices that are on the explosive rise after commercialization of fifth-generation (5G) communication systems are expected to be connected to communication networks. As examples of things connected to networks, there may be cars, robots, drones, home appliances, displays, smart sensors installed in various infrastructures, construction machinery, factory equipment, etc. Mobile devices are expected to evolve into various form factors such as augmentation reality (AR) glasses, virtual reality (VR) headsets, hologram devices, and the like. In order to provide various services by connecting hundreds of billions of devices and things in the sixth-generation (6G) era, there are ongoing efforts to develop better 6G communication systems. For these reasons, 6G communication systems are referred to as beyond-5G systems.

In the 6G communication system expected to become a reality by around 2030, a maximum transfer rate is tera bits per second (bps), i.e., 1000 giga bps, and a maximum wireless delay is 100 micro seconds (μsec). In other words, compared to the 5G communication system, the transfer rate becomes 50 times faster and the wireless delay is reduced to a tenth ( 1/10) in the 6G communication system.

To attain these high data transfer rates and ultra-low delay, the 6G communication system is considered to be implemented in the terahertz (THz) band (e.g., ranging from 95 gigahertz (GHz) to 3 THz). Due to the more severe path loss and atmospheric absorption phenomenon in the THz band as compared to the millimeter wave (mmWave) band introduced in 5G systems, importance of technology for securing a signal range, i.e., coverage, is expected to grow. As major technologies for securing coverage, radio frequency (RF) elements, antennas, new waveforms superior to orthogonal frequency division multiplexing (OFDM) in terms of coverage, beamforming and massive multiple-input and multiple-output (massive MIMO), full dimensional MIMO (FFD-MIMO), array antennas, multiple antenna transmission technologies such as large scale antennas, etc., need to be developed. Besides, new technologies for increasing coverage of THz band signals, such as metamaterial based lenses and antennas, a high-dimensional spatial multiplexing technique using orbital angular momentum (OAM), reconfigurable intelligent surface (RIS), etc., are being discussed.

Furthermore, in order to enhance frequency efficiency and system networks, a full duplex technology by which both uplink and downlink transmissions use the same frequency resource at the same time, a network technology that comprehensively uses satellite and high-altitude platform stations (HAPS) and the like, a network structure innovation technology supporting mobile base stations and allowing optimization and automation of network operation, a dynamic spectrum sharing technology through collision avoidance based on spectrum usage prediction, an artificial intelligence (AI) based communication technology to realize system optimization by using AI from the designing stage and internalizing an end-to-end AI supporting function, a next generation distributed computing technology to realize services having complexity beyond the limit of terminal computing capability by using ultrahigh performance communication and computing resources (e.g., mobile edge computing (MEC) cloud) are being developed in the 6G communication system. In addition, by designing new protocols to be used in 6G communication systems, developing mechanisms for implementing a hardware-based security environment and safe use of data, and developing technologies for protecting privacy, attempts to strengthen connectivity between devices, further optimize the network, promote softwarization of network entities, and increase the openness of wireless communication are continuing.

With such research and development of the 6G communication system, it is expected that new levels of the next hyper-connected experience become possible through hyper-connectivity of the 6G communication system including not only connections between things but also connections between humans and things. Specifically, it is predicted that services such as truly immersive extended reality (truly immersive XR), high-fidelity mobile hologram, digital replica, etc., may be provided. Furthermore, services such as remote surgery, industrial automation and emergency response with enhanced security and reliability may be provided through the 6G communication system to be applied in various areas such as industry, medical care, vehicles, appliances, etc.

### DISCLOSURE

### Technical Problem

The disclosure is to provide a base station, to which a near field reflecting intelligent surface is coupled, and a method of operating the base station.

### Technical Solution

According to an embodiment of the disclosure, a base station (BS) including a near field reflecting(or reconfigurable) intelligent surface (RIS) may be provided. The BS may include the near field RIS including at least one meta surface which reflects an RIS beam into a target area, a transceiver and a processor. The processor may be configured to identify an operation mode among a normal mode or an RIS mode based on whether the target area is included in reflecting beam coverage, and control the transceiver to transmit the RIS beam onto the meta surface based on at least one of a type of the near field RIS, configuration information of the near field RIS or information about the target area, in response to the operation mode being identified as the RIS mode. The type of the near field RIS may be identified as a passive type, an active type or a hybrid type based on the type of the meta surface included in the near field RIS, and the configuration information of the near field RIS may be generated based on the type of the meta surface.

According to an embodiment of the disclosure, a method of operating a BS including a near field RIS in a wireless communication system may be provided. The method of operating the BS may include: identifying an operation mode among a normal mode or an RIS mode based on whether the target area is included in reflecting beam coverage; and transmitting an RIS beam onto a meta surface based on at least one of a type of a near field RIS, configuration information of the near field RIS or information about the target area, in response to the operation mode being identified as the RIS mode. For example, the near field RIS may include at least one meta surface which reflects the RIS beam to the target area, the type of the near field RIS may be identified as a passive type, an active type or a hybrid type based on a type of the meta surface included in the near field RIS, and the configuration information of the near field RIS may be generated based on the type of the meta surface.

### DESCRIPTION OF DRAWINGS

FIG. 1 illustrates beam coverage of a base station (BS) antenna.

FIG. 2 is a diagram for describing beam coverage, a shadow area and a reflecting intelligent surface (RIS) of a BS.

FIG. 3 is a diagram for describing a near field RIS, according to an embodiment of the disclosure.

FIG. 4 is a diagram for explaining a beam scanning method of a BS, according to an embodiment of the disclosure.

FIG. 5 is a diagram for describing a beam coverage expansion method using a near field RIS, according to an embodiment of the disclosure.

FIG. 6 is a diagram for describing structures of an integrated-type BS and a near field RIS, according to an embodiment of the disclosure.

FIG. 7 is a diagram for describing how a near field RIS operates in a normal mode, according to an embodiment of the disclosure.

FIG. 8 is a diagram for describing how a near field RIS operates in an RIS mode, according to an embodiment of the disclosure.

FIG. 9 is a diagram for describing a meta surface on a passive type of near field RIS, according to an embodiment of the disclosure.

FIGS. 10A and 10B are diagrams for describing how a passive type of near field RIS operates in an RIS mode, according to an embodiment of the disclosure.

FIG. 11 is a diagram for describing a meta surface on an active type of near field RIS, according to an embodiment of the disclosure.

FIGS. 12A and 12B are diagrams for describing how an active type of near field RIS operates in an RIS mode, according to an embodiment of the disclosure.

FIG. 13 is a diagram for describing how to expand beam coverage with a passive type of near field RIS, according to an embodiment of the disclosure.

FIG. 14 is a diagram for describing how to expand beam coverage with an active type of near field RIS, according to an embodiment of the disclosure.

FIGS. 15A and 15B are diagrams for describing a case that a near field RIS is coupled to an access point in an indoor environment, according to an embodiment of the disclosure.

FIG. 16 is a flowchart for describing how a BS including a near field RIS operates in a wireless communication system, according to an embodiment of the disclosure.

FIG. 17 is a schematic block diagram of a structure of a BS, according to an embodiment of the disclosure.

### BEST MODE

According to the disclosure, a base station (BS) including a near field reflecting intelligent surface (RIS) may include the near field RIS including at least one meta surface which reflects an RIS beam into a target area, a transceiver and a processor. The processor may be configured to identify an operation mode among a normal mode or an RIS mode based on whether the target area is included in reflecting beam coverage, and control the transceiver to transmit the RIS beam onto the meta surface based on at least one of a type of the near field RIS, configuration information of the near field RIS or information about the target area, in response to the operation mode being identified as the RIS mode.

### MODE FOR INVENTION

In the following descriptions of the disclosure, well-known functions or configurations are not described in detail because they would obscure the disclosure with unnecessary details. Embodiments of the disclosure will now be described with reference to accompanying drawings.

Advantages and features of the disclosure, and methods for attaining them will be understood more clearly with reference to the following embodiments of the disclosure, which will be described in detail at a later time along with the accompanying drawings. The embodiments of the disclosure may, however, be embodied in many different forms and should not be construed as limited to the embodiments set forth herein; rather, these embodiments of the disclosure are provided so that this disclosure will be thorough and complete, and will fully convey the scope of the embodiments of the disclosure to those of ordinary skill in the art. Like numbers refer to like elements throughout the specification.

It will be understood that each block and combination of the blocks of a flowchart may be performed by computer program instructions. The computer program instructions may be loaded onto a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-executable or computer-readable memory that may direct the computers or other programmable data processing apparatus to function in a particular manner, such that the instructions stored in the computer-executable or computer-readable memory may produce an article of manufacture including instruction means that perform the functions specified in the flowchart blocks(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments. For example, two successive blocks may be performed substantially at the same time or in reverse order depending on the corresponding functions.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a small number of components and modules, or further divided into a larger number of components and modules. Moreover, the components and modules may be implemented to execute one or more central processing units (CPUs) in a device or security multimedia card. In embodiments, the module may include one or more processors.

In the following descriptions of the disclosure, well-known functions or configurations are not described in detail because they would obscure the disclosure with unnecessary details. Embodiments of the disclosure will now be described with reference to accompanying drawings.

In the following description, a base station is an entity for performing resource allocation for a terminal, and may be at least one of a gNB, an eNB, a Node B, a base station (BS), a radio access unit, a base station controller, or a network node. The terminal may include a user equipment (UE), a mobile station (MS), a cellular phone, a smart phone, a computer, or a multimedia system capable of performing a communication function. It is, of course, not limited thereto.

According to an embodiment of the disclosure, a method of expanding beam coverage of a BS may be provided.

According to an embodiment of the disclosure, a method of expanding beam coverage of a BS may be provided by implementing a BS integrated reflecting intelligent surface (RIS).

According to an embodiment of the disclosure, a method of expanding beam coverage through a beam in a steering (or beamforming) direction not used before may be provided.

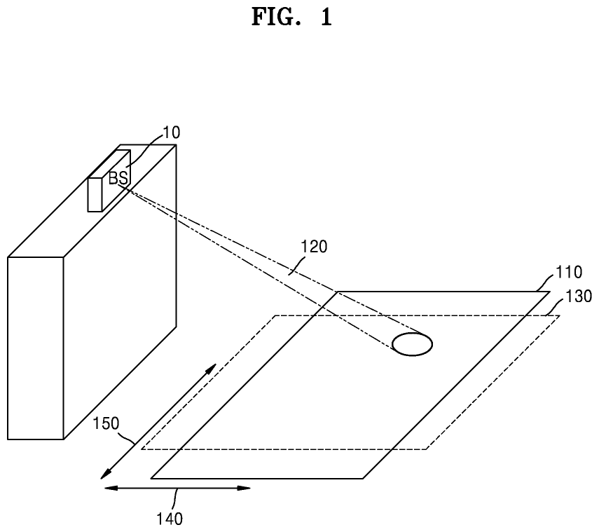

FIG. 1 illustrates beam coverage of a BS antenna.

The BS 10 may include an antenna for communication. Especially, when the BS 10 transmits a signal or data in a frequency resource having a wavelength of a millimeter wave or less, a larger path loss than in a case of using a frequency resource having a wavelength of larger than a millimeter wave may occur in a communication environment. Communication systems may require a higher gain than before to overcome the path loss, and to attain the higher gain, the BS 10 may use an array antenna.

The BS 10 may perform beamforming 120 by adjusting the phase of the array antenna to obtain desired beam coverage 110. It is hard to physically increase the beam coverage 110 that may be obtained by the BS 10 with the use of the array antenna once the number of arrays of the antenna is fixed. The BS 10 may commonly include a planar type array antenna. Hence, the beam coverage 110 formed by the antenna of the BS 10 may have a trade-off between a vertical direction 140 and a horizontal direction 150. The trade-off may occur equally across the array antenna, so the array antenna forms the limited beam coverage 110.

Referring to FIG. 1, when the BS 10 intends to expand beam coverage to a particular direction, coverage may be reduced in the other direction. Referring to FIG. 1, when the BS 10 intends to obtain beam coverage 130 expanded in the vertical direction, the BS 10 obtains shorter beam coverage in the horizontal direction than the beam coverage 110 expanded in the horizontal direction. As a non-exclusive example, with the antenna, the BS 10 generally prefers the beam coverage 110 expanded in the horizontal direction 150 to a beam coverage expanded in the vertical direction 140. Hence, the BS 10 may be designed to obtain the beam coverage 110 that is wide in the horizontal direction 150 but narrow in the vertical direction 140.

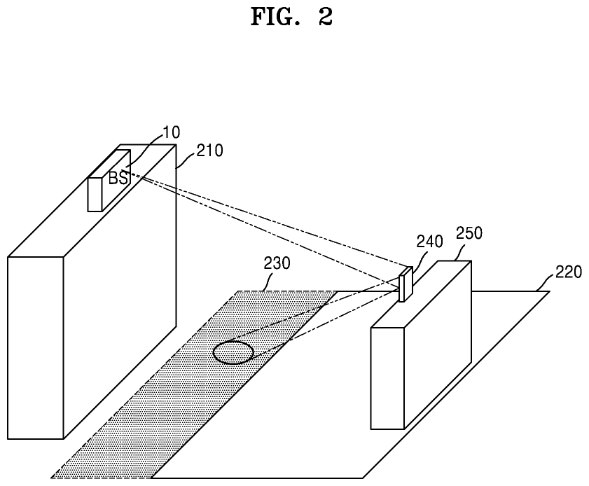

FIG. 2 is a diagram for describing beam coverage, a shadow area and a reflecting (or reconfigurable) intelligent surface (RIS) of a BS.

In the disclosure, an RIS 240 may refer to an intelligent meta surface.

As described above, when the BS 10 is designed to have a wide beam in the horizontal direction with respect to the BS 10, limited beam coverage may be obtained in the vertical direction with respect to the BS 10. As a non-exclusive example, the BS 10 may be installed on a building 210. In this case, the BS may obtain beam coverage 220. When the BS 10 is installed on the building 210, it is difficult for the BS 10 to cover an area near the building 210 in a direction to the ground below the building 210. Especially, a phenomenon of occurrence of a shadow area 230 becomes more severe when the communication system uses a frequency of a millimeter wave or a higher frequency. It is because, when the frequency of the millimeter wave or higher frequency is used, the radio waves have strong linearity and it is not possible to have a coverage expansion effect from scattering or diffraction. As horizontal coverage is reduced when the communication system intends to increase vertical coverage to cover the shadow area 230, it is not a proper method (due to the trade-off relationship). Furthermore, as the array antenna is implemented on a plane parallel with the BS 10, it is difficult to physically perform beamforming with the antenna into the shadow area 230 below the building 210.

The easiest way to improve beam coverage to improve the shadow area 230 is to design an additional antenna to cover the shadow area 230. However, the designing of the additional antenna needs to involve generating and transmitting an additional signal for operation of the antenna additionally installed to cover the shadow area 230. Hence, this makes the BS 10 consume more power. It has another disadvantage in that additional circuit design, an increase in number of chips, etc., further increase complexity.

As a way to improve communication environments, there is the traditional RIS 240 of FIG. 2. However, this has a disadvantage in that it is necessary to have a building 250 (e.g., a building or structure) on which to install the RIS 240. The method that uses the traditional RIS 240 causes an increase of expense. Furthermore, in the case of FIG. 2 that the systems are separately implemented, a wired link or wireless link is required for communication between the BS 10 and the RIS 240. This is not technically easy in design. Moreover, in this case, the RIS 240 needs to be implemented in the communication range of the existing BS 10 and its design and performance depends on an installation environment of the BS 10, so actual implementation thereof requires much financial and time-consuming effort. Lastly, the method may not provide an effect of increasing the actual communication range (i.e., the beam coverage 220) of the BS 10 in the communication environment.

Accordingly, the disclosure proposes a method of increasing the beam coverage 220 by covering the shadow area 230 created around the existing BS 10. In another embodiment of the disclosure, a new BS designing method is used to dispense with the need to design an additional circuit, increase the number of chips or for extra power. The disclosure proposes a method of increasing the beam coverage 220 of the BS 10 itself through structurally additional design with the use of an antenna included in the existing BS 10.

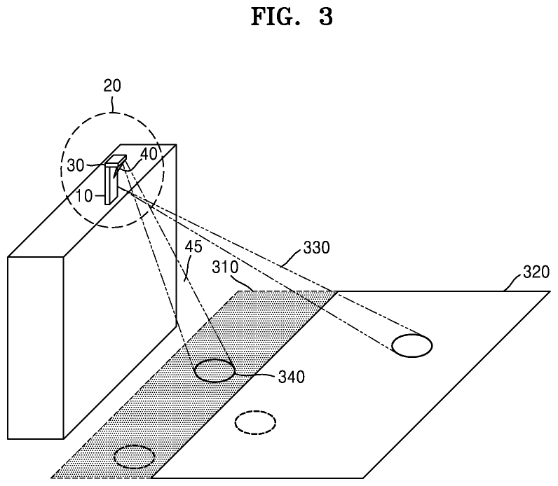

FIG. 3 is a diagram for describing a near field RIS, according to an embodiment of the disclosure.

For example, FIG. 3 illustrates an example of expanding beam coverage 320 with a nearfield RIS 30 coupled to the BS 10 on a building. In an embodiment of the disclosure, an integrated-type BS 20 may include the near field RIS 30 to expand the beam coverage 320 into a shadow area that is not covered by the existing BS 10. In the disclosure, the integrated-type BS 20 may refer to a BS with the existing BS 10 coupled with the near field RIS 30. In the disclosure, the near field RIS 30 may include a meta surface, which may correspond to a near field intelligent meta surface, a BS-integrated intelligent meta surface, an intelligent meta surface, etc.

To be distinguished from the existing BS 10, the BS including the near field RIS 30 according to an embodiment of the disclosure will be stated as the integrated-type BS 20.

In an embodiment of the disclosure, the near field RIS 30 may include at least one meta surface that reflects an RIS beam 40 into a target area 340. In the disclosure, an antenna gain of the RIS beam 40 may correspond to a value lower than a reference antenna gain. The reference antenna gain may be a value preset based on a communication system including the near field RIS 30, a communication environment, an antenna, etc., but is not limited to the aforementioned example. Furthermore, the RIS beam 40 may refer to a beam formed at a larger or smaller tilt angle of the BS than a preset threshold tilt angle.

In the disclosure, a coverage beam 330 may correspond to a beam directed toward the beam coverage 320 of the BS 10. Furthermore, an antenna gain of the coverage beam 330 may correspond to a value equal to or higher than the reference antenna gain. Furthermore, the coverage beam 330 may refer to a beam formed at a tilt angle of the BS within a preset threshold tilt angle range.

In the disclosure, the beam coverage 320 may correspond to an area other than a reflective beam coverage 310. The reflective beam coverage 310 may correspond to a shadow area.

Referring to FIG. 3, the near field RIS 30 may be implemented in a near field area of the BS 10. In the disclosure, the near field area may refer to an area in a range preset based on the BS 10 or the antenna array of the BS 10. For example, the near field area may refer to an ultrasonic beam area in which sound pressure may not be directly related with the distance due to interference.

For example, the near field RIS 30 may be located above the antenna array (not shown) of the BS 10. Referring to FIG. 3, the near field RIS 30 may be installed at a location where it is able to reflect a beam transmitted by the antenna array of the BS 10 to the near field RIS 30.

In an embodiment, the location where the near field RIS 30 is installed is not limited to a particular location of the BS 10. For example, the near field RIS 30 may be installed within a preset range from the BS 10. Furthermore, the near field RIS 30 may be installed in a way of being fixed to the BS, or the near field RIS 30 may be coupled with the BS 10.

In another embodiment, a control line may be additionally implemented between the near field RIS 30 and the BS 10.

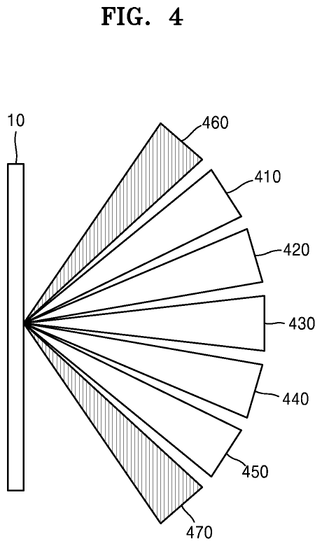

FIG. 4 is a diagram for explaining a beam scanning method of a BS, according to an embodiment of the disclosure.

Referring to FIG. 4, the existing BS 10 may generate a beam with the use of the array antenna. Furthermore, the BS 10 may steer (or beamform) the beam into a desired area according to a phase at which the beam is applied to the array antenna. The BS 10 may use the array antenna to transmit coverage beams 410, 420, 430, 440 and 450 and obtain a desired antenna gain in the beam coverage.

However, when the BS 10 uses a beam 460 or 470 that deviates from the coverage beams 410, 420, 430, 440 and 450 by at least a certain angle, the gain of the antenna is reduced so that the desired antenna gain may not be obtained, so the beam 460 or 470 is a beam of no use.

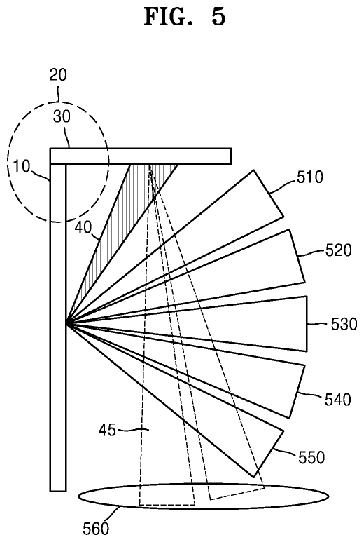

FIG. 5 is a diagram for describing a beam coverage expansion method using the near field RIS 30, according to an embodiment of the disclosure.

Referring to FIG. 5, a beamforming operation procedure of the integrated-type BS 20 including the near field RIS 30 will be described with the use of a vertical cross-section. Referring to FIG. 5, the integrated-type BS 20 with which the near field RIS 30 is coupled operates the same way in the beam coverage the BS 10 has. In other words, when the integrated-type BS 20 transmits beams into the beam coverage, it may use coverage beams 510, 520, 530, 540 and 550.

In an embodiment of the disclosure, the integrated-type BS 20 may provide a beam coverage expansion method by using beams in a direction in which the existing BS 10 has not steered. The integrated-type BS 20 may steer the RIS beam 40 onto the nearfield RIS 30, and the RIS beam 40 may be reflected off the near field RIS 30 into a target area belonging to reflecting beam coverage 560. In this case, the near field RIS 30 may be easily designed by the designer to have beam coverage to be expanded as a target. Specifically, the integrated-type BS 20 may steer the RIS beam 40 to perform communication even outside the existing beam coverage (i.e., in the reflecting beam coverage 560) by using the coverage beams 510, 520, 530, 540 and 550 for beamforming in the beam coverage of the existing BS 10 and using the near field RIS 30 only when required.

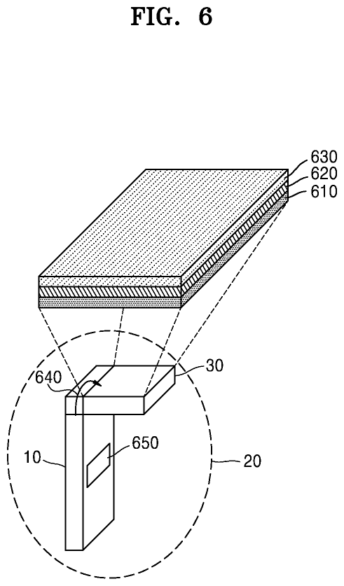

FIG. 6 is a diagram for describing structures of the integrated-type BS 20 and the near field RIS 30, according to an embodiment of the disclosure.

In a non-exclusive embodiment, the integrated-type BS 20 may be located on a building, and the near field RIS 30 included in the integrated-type BS 20 may be attached onto the top of the BS 10.

In an embodiment, the near field RIS 30 may include three layers 610, 620 and 630 as shown in FIG. 6. For example, the near field RIS 30 may include at least one layer of a meta surface 610, a bias line 620 or a control board 630. However, the near field RIS 30 as shown in FIG. 6 may only include at least one of the three layers but may not always include all the three layers.

In an embodiment, the near field RIS 30 may include the meta surface 610 as a bottommost layer. The meta surface 610 may reflect a beam steered from the integrated-type BS 20. For example, beams steered from an antenna of the integrated-type BS 20 may all be reflected from the reflecting meta surface 610. For example, the meta surface 610 may be variously designed according to requirements or types.

In an embodiment, the near field RIS 30 may include the bias line 620. For example, the bias line 620 may be formed as a layer on the meta surface 610. When the near field RIS 30 is formed to have an active type (e.g., an active type of the meta surface 610), the bias line 620 may control a switch device included in the meta surface 610. As a non-exclusive example, the switch device may include a PIN diode.

In an embodiment, the near field RIS 30 may include the control board 630 as an uppermost layer. In case that the near field RIS 30 is formed to have an active type (e.g., the meta surface 610 has an active type), the control board 630 may include a circuit to operate the meta surface 610 through the bias line 620 of the middle layer. For example, the control board 630 may include a circuit to control the switch device of the meta surface 610 for beamforming.

As it is the BS 20 that controls the near field RIS 30, an RIS control line 640 may be included to connect between the BS 10 and the near field RIS 30 so as for the integrated-type BS 20 to actively control the meta surface 610.

In another example, in case that the near field RIS 30 is formed in a passive type (e.g., the meta surface 610 has a passive type), the at least one bias line 620 or control board 630 may not be included in the near field RIS 30. Furthermore, the near field RIS 30 may be formed of a single layer (e.g., the meta surface 610). Furthermore, the integrated-type BS 20 may not include the RIS control line 640 that connects between the BS 10 and the near field RIS 30. The aforementioned layers are merely an example, and are not limited to what are described above but may be implemented in various methods as needed.

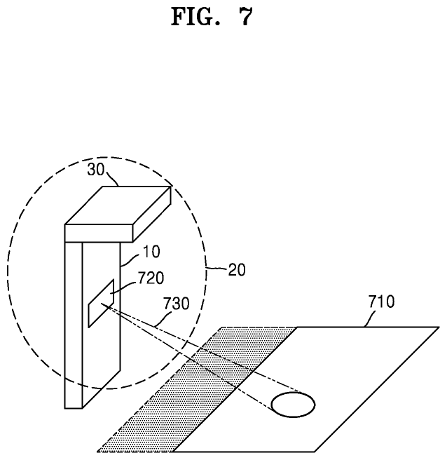

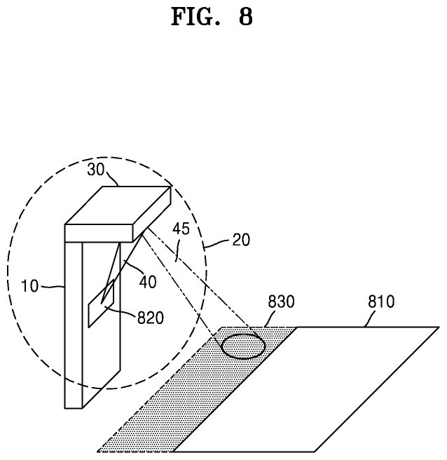

In an embodiment, the near field RIS 30 may operate in two modes. Operations in a normal mode will be described in connection with FIG. 7, and operations in an RIS mode will be described in connection with FIG. 8.

FIG. 7 is a diagram for describing how a near field RIS 30 operates in the normal mode, according to an embodiment of the disclosure.

In case that the integrated-type BS 20 operates the near field RIS 30 in the normal mode, it may obtain beam coverage 710 of the existing BS 10. In the normal mode, the near field RIS 30 may not operate but may be in an idle state. The integrated-type BS 20 may obtain desired beam coverage 710 through beamforming of an array antenna 720 in the same procedure as with the existing BS 10. In this case, the integrated-type BS 20 may transmit a coverage beam 730 into the beam coverage 710.

FIG. 8 is a diagram for describing how the near field RIS 30 operates in the RIS mode, according to an embodiment of the disclosure.

The integrated-type BS 20 may operate the near field RIS 30 in the RIS mode to obtain expanded beam coverage.

The integrated-type BS 20 may steer an array antenna 820 for the RIS beam 40 to be directed to the near field RIS 30 instead of a direction toward beam coverage 810 into which beamforming has originally been performed. In an embodiment, the near field RIS 30 may be in an operating state. Beams received from the array antenna 820 of the integrated-type BS 20 may be reflected by the near field RIS 30 back into a desired direction. In this case, referring to FIG. 8, a reflective beam 45 reflected by the near field RIS 30 may be transmitted into reflecting beam coverage 830.

The array antenna 820 may be an actual emitting source that emits radio waves. Hence, according to an embodiment of the disclosure, it is possible to use the array antenna 820 of the BS 10, so no extra circuit is designed for the array antenna 820 of the existing BS 10 and no further chip is needed.

Operating schemes and performance in the RIS mode may differ depending on whether the near field RIS 30 according to an embodiment is formed in the active type (e.g., the meta surface 610 has the active type) or in the passive type (e.g., the meta surface 610 has the passive type). Structures and operating methods of the meta surface based on active, passive and hybrid types will be described in connection with drawings which will be described below.

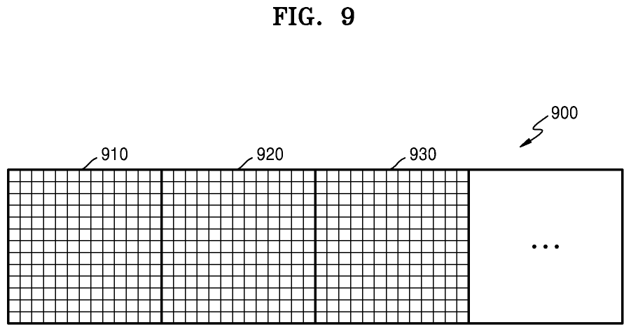

FIG. 9 is a diagram for describing a meta surface on a passive type of near field RIS 30, according to an embodiment of the disclosure.

In an embodiment, the type of the near field RIS 30 may correspond to a passive type. For example, a meta surface 900 included on the near field RIS 30 may be formed in a passive type. Furthermore, the meta surface 900 may include at least one reflecting area 910, 920 and 930.

In case that the near field RIS 30 has the passive type, the meta surface 900 may have been designed in a predefined pattern. The integrated-type BS 20 may obtain configuration information of the near field RIS 30. In an embodiment of the disclosure, the configuration information of the near field RIS may include at least one of pattern ENGLISH TRANSLATION OF THE INTERNATIONAL APPLICATION information of the meta surface 900 (i.e., design information of the meta surface 900), information about at least one reflecting area 910, 920 or 930 or information of an RIS beam corresponding to a target area.

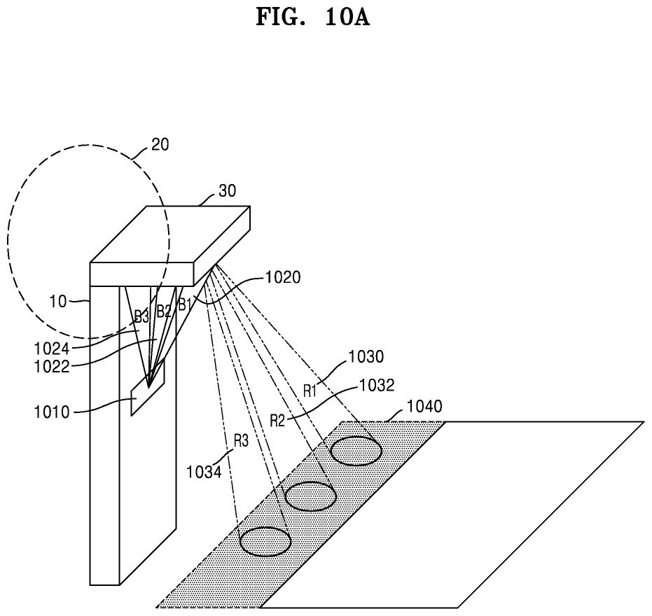

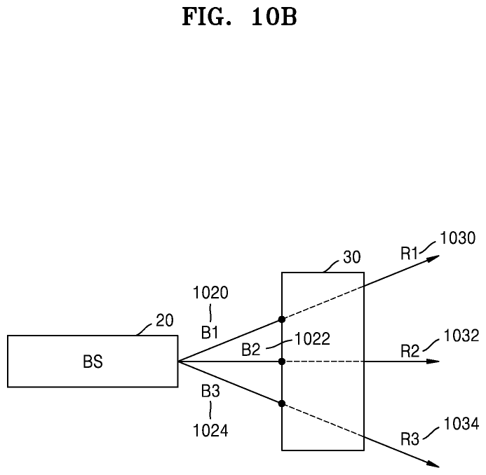

FIGS. 10A and 10B are diagrams for describing how a passive type of near field RIS 30 operates in an RIS mode, according to an embodiment of the disclosure.

Referring to FIGS. 10A and 10B, the integrated-type BS 20 may use an array antenna 1010 to steer three types of beams B1 1020, B2 1022 or B3 1024 toward the passive type of near field RIS 30 (i.e., the meta surface 900 designed in a passive type). Based on the designed meta surface 900, the near field RIS 30 may reflect B1 1020, B2 1022 or B3 1024 to a direction R1 1030, R2 1032 or R3 1034, respectively, to be steered into reflecting beam coverage 1040, which is a shadow area.

In other words, the meta surface 900 may be designed to reflect the RIS beam 40 to a desired direction to be steered into a shadow area, reflecting beam coverage 1040, in case that information about the beam to be steered onto the meta surface 900 is identified. As the meta surface 900 is not changed once it is formed, it may be called a passive type. It is advantageous that there is no need for extra design for the near field RIS 30 once the near field RIS 30 is formed in the passive type.

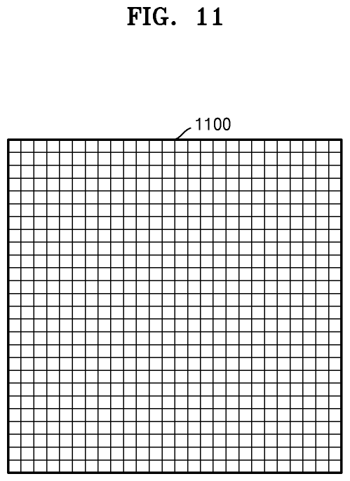

FIG. 11 is a diagram for describing a meta surface on an active type of near field RIS 30, according to an embodiment of the disclosure.

In an embodiment, the type of the near field RIS 30 may correspond to an active type. For example, a meta surface 1000 included on the near field RIS 30 may be formed of at least one active type elements. The meta surface 1000 included on the near field RIS 30 may include reconfigurable elements.

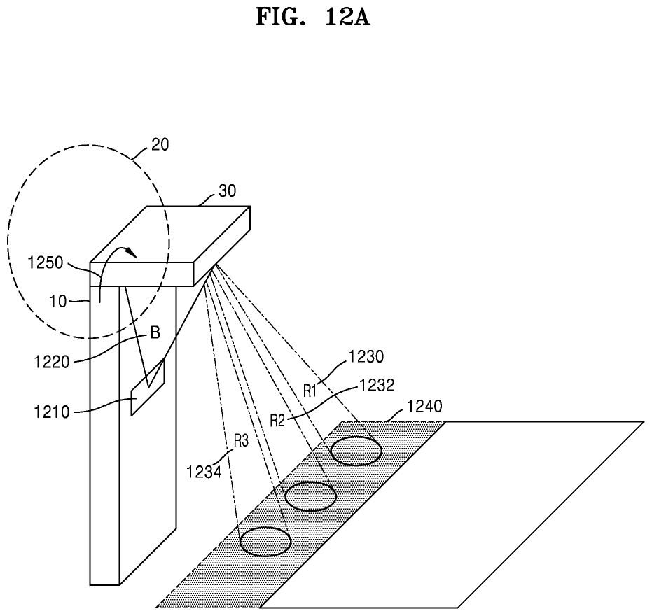

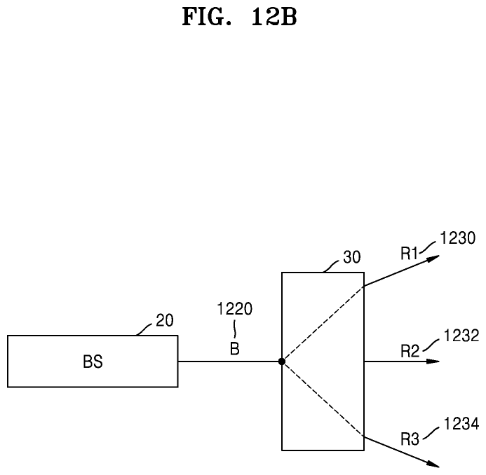

FIGS. 12A and 12B are diagrams for describing how an active type of near field RIS 30 operates in an RIS mode, according to an embodiment of the disclosure.

An active type of meta surface 1100 may refer to the meta surface 1100 implemented to be able to change the beamforming direction by changing reflection properties on the meta surface 1100.

Referring to FIGS. 12A and 12B, the integrated-type BS 20 may use the array antenna 1210 to steer a single beam B 1220 toward the active type of near field RIS 30 (i.e., the meta surface 1100 designed in an active type). Unlike the passive type of near field RIS 30 as described above in FIGS. 10A and 10B, the integrated-type BS 20 according to an embodiment may transmit a beam optimized for the active type of near field RIS 30. This is equal to optimizing beam patterns of a feeder antenna when a reflector antenna is implemented. The active type of meta surface 1100 may use reconfigurable elements to reflect an RIS beam (e.g., B 1220 in FIGS. 12A and 12B) received from the array antenna 1210 toward a shadow area, reflecting beam coverage 1240 to which expansion is intended.

In the case of the active type of near field RIS 30 (i.e., the meta surface 1100 designed in an active type), the integrated-type BS 20 may include a control line 1250 between the BS 10 and the meta surface 1100. In an embodiment, as the BS 10 and the meta surface 1100 may be physically coupled together, it may be easy to design the control line 1250. It is advantageous that a desired beam may be freely reflected from the single beam B 1220 received from the integrated-type BS 20 in case that the near field RIS 30 is formed in the active type.

In another embodiment of the disclosure, the near field RIS 30 may correspond to a near field RIS of a hybrid type including a meta surface formed of the passive type of meta surface 900 and the active type of meta surface 1100. For example, the integrated-type BS 20 may use both the passive type of meta surface 900 and the active type of meta surface 1100 included on the near field RIS 30 to reflect the RIS beam 40 so that a reflective beam reflected from the RIS beam 40 is transmitted to a specified shadow area.

In another example, the integrated-type BS 20 may use the active type of meta surface 1100 included in the near field RIS 30 to reflect the RIS beam 40. In this case, the RIS beam 40 may be classified into multiple types, and the meta surface may be divided into at least one reflecting area (part). The hybrid type comes only by proper implementation of a switch, so its complexity does not significantly increase.

In an embodiment, the integrated-type BS 20 may use the hybrid type of near field RIS to reflect the RIS beam 40 to be transmitted to the entire reflecting beam coverage.

In another embodiment, the integrated-type BS 20 may classify the reflecting beam coverage into first reflecting beam coverage and second reflecting beam coverage. In this case, the integrated-type BS 20 may reflect the RIS beam into the first reflecting beam coverage by using the passive type of meta surface 900 and may reflect the RIS beam into the second reflecting beam coverage by using the active type of meta surface 1100. In this case, the BS may identify a target area into which to transmit a beam, and based on the target area, identify into which area of the first reflecting beam coverage and the second reflecting beam coverage the beam is to be transmitted and what type of meta surface is to be used.

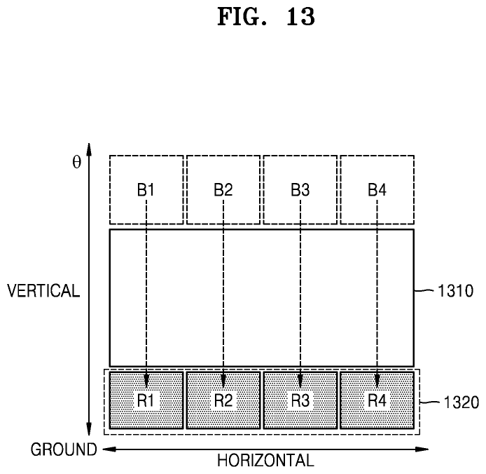

FIG. 13 is a diagram for describing how to expand beam coverage with the passive type of near field RIS 30, according to an embodiment of the disclosure.

Referring to FIG. 13, in order to cover reflecting beam coverage 1320 (i.e., a shadow area) in addition to existing beam coverage 1310, a meta surface that is able to reflect various beams received from the antenna of the BS onto a surface wider than with the active type may be designed for the passive type of near field RIS 30 (see FIG. 9). The meta surface 900 may each be designed to perform steering toward a shadow area to be covered.

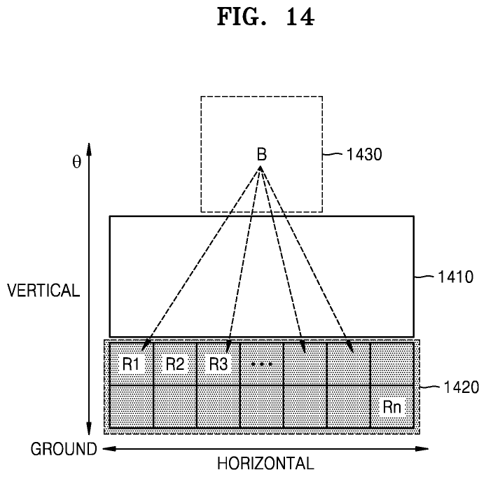

FIG. 14 is a diagram for describing how to expand beam coverage with the active type of near field RIS 30, according to an embodiment of the disclosure.

The active type of near field RIS 30 may change properties of a beam reflected off the meta surface by using variable elements to form a beam to cover reflecting beam coverage 1420 (i.e., a shadow area) when the BS steers an optimized beam 1430. Hence, the active type of near field RIS 30 may form various beams as compared to the passive type (see FIG. 11).

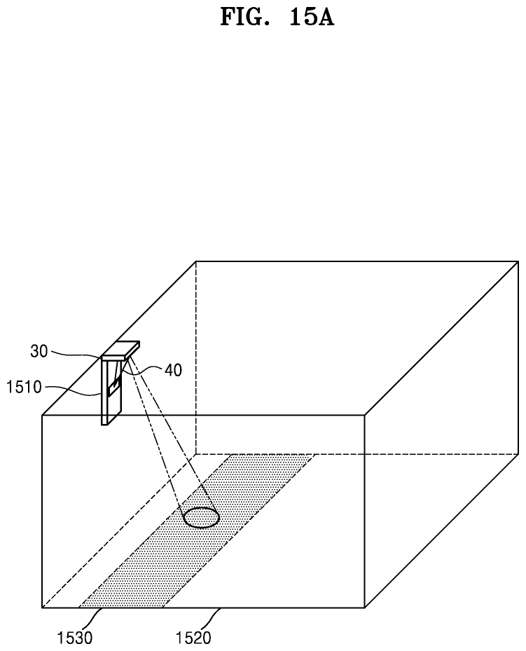

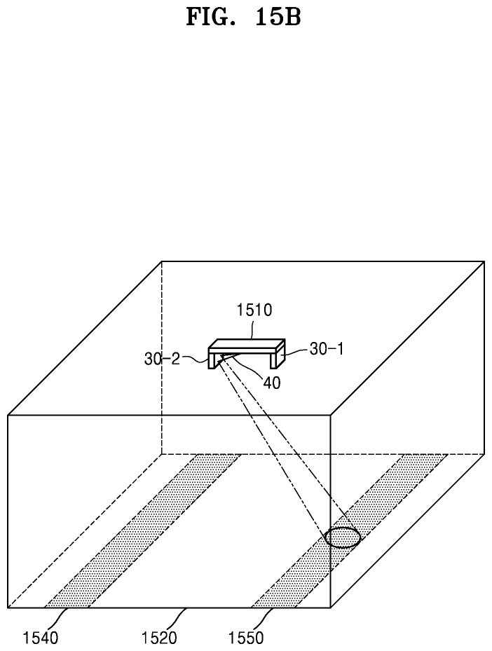

FIGS. 15A and 15B are diagrams for describing a case that the near field RIS 30 is coupled to an access point in an indoor environment, according to an embodiment of the disclosure.

A BS-integrated intelligent meta surface may be implemented for the purpose of improving coverage in various scenarios, and may be used not only in an outdoor environment but also in an indoor access point as shown in FIGS. 15A and 15B. In the case of indoor implementation in particular, deterioration of fine appearance due to the meta surface may be compensated on the assumption of wall or ceiling installation.

FIG. 15A illustrates an indoor environment where an access point 1510 is installed on an indoor wall, according to an embodiment. For example, the near field RIS 30 may be located in a space above the access point 1510. In this case, the near field RIS 30 ENGLISH TRANSLATION OF THE INTERNATIONAL APPLICATION may be located in a near field area of the access point 1510. The near field RIS 30 may reflect the RIS beam 40 transmitted from the access point 1510 not into beam coverage 1520 but into beam coverage 1530 (i.e., a shadow area).

FIG. 15B illustrates an indoor environment where the access point 1510 is installed on a ceiling, according to an embodiment. For example, a first near field RIS 30-1 and a second near field RIS 30-2 may be located in left and right spaces to the access point 1510, respectively. In this case, the first near field RIS 30-1 and the second near field RIS 30-2 may be located in a near field area of the access point 1510. The first near field RIS 30-1 and the second near field RIS 30-2 may reflect the RIS beam 40 transmitted from the access point 1510 not into beam coverage 1520 but into first reflecting beam coverage 1540 or second reflecting beam coverage 1550.

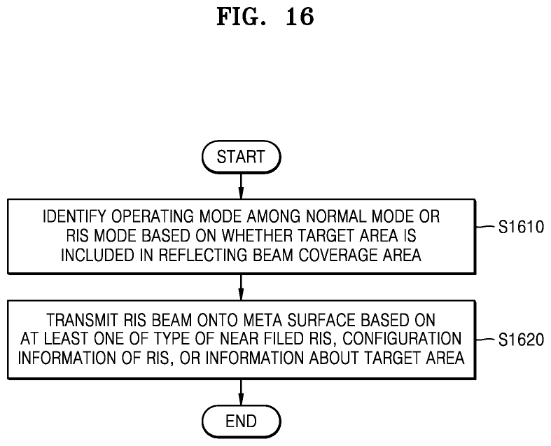

FIG. 16 is a flowchart for describing how a BS including a near field RIS operates in a wireless communication system, according to an embodiment of the disclosure.

Description overlapping with the foregoing will not be repeated. In an embodiment of the disclosure, the near field RIS 30 may include at least one meta surface that reflects the RIS beam 40 into a target area.

In operation S1610, the integrated-type BS 20 may identify an operation mode among a normal mode or an RIS mode based on whether the target area is included in reflecting beam coverage.

In an embodiment of the disclosure, the integrated-type BS 20 may use at least one of the RIS beam 40 or a coverage beam to identify the target area. The identified-type BS 20 may find a user who will perform communication, while performing a search operation. In the process of the searching, the integrated-type BS 20 may search for a user by using the RIS beam 40 or the coverage beam, and may operate in the normal mode in case that the user is identified as being in the existing communication range. In another example, in case that it is identified that the user is in an area (i.e., reflecting beam coverage) found by using the RIS beam 40, the integrated-type BS 20 may use the near field RIS 30 to operate in the RIS mode to reflect the RIS beam 40.

In an embodiment of the disclosure, in case that the target area is identified as being included in the reflecting beam coverage, the operation mode may be identified as the RIS mode.

In an embodiment of the disclosure, in case that the target area is identified as being included in the beam coverage, the identified-type BS 20 may identify the operation mode as the normal mode. In response to the operation mode identified as the normal mode, the integrated-type BS 20 may transmit the coverage beam to the target area included in the beam coverage. The beam coverage may correspond to an area except for the reflecting beam coverage, and the reflecting beam coverage may correspond to a shadow area. The antenna gain of the coverage beam may correspond to a value equal to or higher than the reference antenna gain. The coverage beam may correspond to a beam directed toward the beam coverage.

In operation S1620, the integrated-type BS 20 may transmit the RIS beam 40 onto a meta surface based on at least one of a type of a near field RIS, configuration information of the near field RIS or information about the target area, in response to the operation mode identified as the RIS mode.

In the disclosure, for example, the antenna gain of the RIS beam 40 may correspond to a value lower than the reference antenna gain.

In the disclosure, the configuration information of the near field RIS 30 may be generated based on the type of the meta surface.

In the disclosure, the type of the near field RIS 30 may be identified as a passive type, an active type or a hybrid type based on the type of the meta surface included in the near field RIS 30.

In an embodiment, in case that the type of the near field RIS 30 corresponds to the passive type, the integrated-type BS 20 may identify the RIS beam 40 corresponding to the target area based on the configuration information of the near field RIS 30 and the information about the target area.

In an embodiment of the disclosure, in case that the type of the near field RIS 30 corresponds to the passive type, the meta surface included in the near field RIS 30 may include at least one reflecting area. The RIS beam 40 may correspond to the at least one reflecting area. The configuration information of the near field RIS 30 may include at least one of at least one reflecting area information or information about the RIS beam 40 corresponding to the target area.

In an embodiment, in case that the type of the near field RIS 30 corresponds to the active type, the integrated-type BS 20 may generate control information for adjusting (or controlling) the reflecting direction of the meta surface based on the configuration information of the near field RIS 30 and the information about the target area. Furthermore, the integrated-type BS 20 may transmit the control information to the near field RIS 30 through a control line. The RIS beam 40 may be reflected by the meta surface into the target area based on the control information.

In an embodiment of the disclosure, in case that the type of the near field RIS 30 corresponds to the active type, the near field RIS 30 may further include at least one of a bias line, a control board or the control line for controlling the switch device included on the meta surface.

In an embodiment of the disclosure, in case that the type of the near field RIS 30 corresponds to the active type, the meta surface included in the near field RIS 30 may include at least one active element. The configuration information of the near field RIS 30 may include information about the at least one active element.

In an embodiment of the disclosure, in case that the type of the near field RIS 30 corresponds to the hybrid type, the near field RIS 30 may include a first section that includes the at least one reflecting area and a second section that includes the at least one active element. The configuration information of the near field RIS 30 may include at least one of information about a first section RIS beam corresponding to the first section, information about the at least one reflecting area included in the first section, information about a second section RIS beam corresponding to the second section or information about the at least one active element included in the second section.

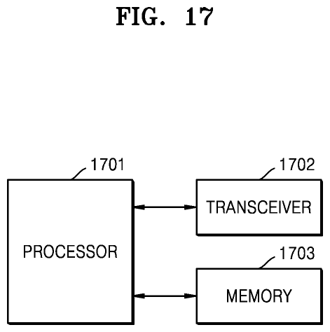

FIG. 17 is a schematic block diagram of a structure of a BS, according to an embodiment of the disclosure.

The BS shown in FIG. 17 may correspond to the BS 10 or the integrated-type BS 20. The integrated-type BS 20 may further include the near field RIS 30 including at least one meta surface which reflects the RIS beam 40 into a target area.

Referring to FIG. 17, the BS may include a processor 1701, a transceiver 1702, and a memory 1703. It is, of course, not limited thereto, and the BS may include more or fewer components than in FIG. 17. The processor 1701, the transceiver 1702 and the ENGLISH TRANSLATION OF THE INTERNATIONAL APPLICATION memory 1703 may be implemented in a single chip. In the disclosure, the processor may be defined to be a circuit, an ASIC, or at least one processor. It is, of course, not limited thereto.

In an embodiment of the disclosure, the BS may further include the near field RIS 30 including at least one meta surface which reflects an RIS beam into a target area.

In an embodiment of the disclosure, the processor 1701 may control general operation of the BS. For example, the processor 1701 may control signal flows among the respective blocks to perform operation according to the aforementioned flowcharts. The processor 1701 may record data to the memory 1703 or read out data from the memory 1020. The processor 1701 may further perform functions of a protocol stack requested by a communication standard. For this, the processor 1701 may include at least one processor or microprocessor, or may be part of a processor. Furthermore, part of the transceiver 1702 and the processor 1701 may be referred to as a communication processor (CP).

The processor 1701 according to an embodiment of the disclosure may control operations of the BS as described above in connection with FIGS. 1 to 16.

In an embodiment of the disclosure, the processor 1701 may execute a program stored in the memory 1703 to determine a type of a channel on which to transmit at least one UL (uplink) control information, provide configuration information for a UE based on a result of the determining, and control the transceiver 1702 to receive at least one UL control information based on the configuration information. In an embodiment of the disclosure, the processor 1701 may execute a program stored in the memory 1703 to control the transceiver 1702 to transmit configuration information about whether to simultaneously transmit a UL control channel and a UL data channel, transmit configuration information about whether to piggyback and transmit UL control information on the UL data channel, transmit scheduling information about at least one of at least one UL control channel and at least one UL data channel, and receive one UL control channel and one UL data channel.

In an embodiment of the disclosure, the transceiver 1702 may perform functions to transmit or receive a signal on a wireless channel. For example, the transceiver 1702 may perform a conversion function between a baseband signal and a bitstream according to a physical layer standard of the system. For example, for data transmission, the transceiver 1702 may generate complex symbols by encoding and modulating a bitstream for transmission. For data reception, the transceiver 1702 may reconstruct a received bitstream by demodulating and decoding the baseband signal. Furthermore, the transceiver 1702 may perform up-conversion on the baseband signal to a radio frequency (RF) band signal and transmit the resultant signal through an antenna, and may perform down-conversion on an RF band signal received through the antenna to a baseband signal. For example, the transceiver 1702 may include a transmit filter, a receive filter, an amplifier, a mixer, an oscillator, a digital-to-analog converter (DAC), an analog-to-digital converter (ADC), etc. The transceiver 1702 may also include a plurality of transmission and reception paths. Furthermore, the transceiver 1702 may include at least one antenna array comprised of a plurality of antenna elements. From the perspective of hardware, the transceiver 1702 may be comprised of a digital circuit and an analog circuit (e.g., a radio frequency integrated circuit (RFIC)). In this case, the digital circuit and the analog circuit may be implemented in a single package. The transceiver 1702 may also include a plurality of RF chains.

In an embodiment of the disclosure, the memory 1703 may store a basic program for operation of the BS, an application program, data like settings information. The memory 1703 may include a volatile memory, a non-volatile memory, or a combination of the volatile memory and the non-volatile memory. The memory 1703 may also provide the stored data at the request of the processor 1701. The memory 1703 may store at least one of information received or for transmission by the transceiver 1702 and information generated by the processor 1701.

In an embodiment of the disclosure, the processor 1701 may identify an operation mode among the normal mode or the RIS mode based on whether the target area is included in the reflecting beam coverage. The processor 1701 may control the transceiver 1702 to transmit the RIS beam onto the meta surface based on at least one of a type of the near field RIS 30, configuration information of the near field RIS 30 or information about the target area, in response to the operation mode being identified as the RIS mode.

In an embodiment of the disclosure, the type of the near field RIS 30 may be identified as a passive type, an active type or a hybrid type based on the type of the meta surface included in the near field. The configuration information of the near field RIS 30 may be generated based on the type of the meta surface.

In an embodiment of the disclosure, in case that the type of the near field RIS 30 corresponds to the active type, the near field RIS 30 may further include at least one of a bias line, a control board or a control line for controlling a switch device included on the meta surface.

In an embodiment of the disclosure, the type of the near field RIS 30 corresponds to the passive type, the meta surface included in the near field RIS 30 may include at least one reflecting area, the RIS beam 40 may correspond to the at least one reflecting area, and the configuration information of the near field RIS 30 may include at least one of information about the at least one reflecting area or information about the RIS beam 40 corresponding to the target area.

In an embodiment of the disclosure, in case that the type of the near field RIS 30 corresponds to the active type, the meta surface included in the near field RIS 30 may include at least one active element and the configuration information of the near field RIS 30 may include information about the at least one active element.

In an embodiment of the disclosure, in case that the type of the near field RIS 30 corresponds to the passive type, the processor 1701 may identify the RIS beam 40 corresponding to the target area based on the configuration information of the near field RIS 30 and the information about the target area.

In an embodiment of the disclosure, in case that the type of the near field RIS 30 corresponds to the active type, the processor 1701 may generate control information for adjusting the reflecting direction of the meta surface and transmit the control information to the near field RIS through the control line.

In an embodiment of the disclosure, the processor 1701 may identify the operation mode as the normal mode in case that the target area is identified as being included in beam coverage, and transmit the coverage beam to the target area included in the beam coverage in response to the operation mode identified as the normal mode.

In an embodiment of the disclosure, the processor 1701 may identify the target area by using at least one of the RIS beam or the coverage beam. In case that the target area is identified as being included in the reflecting beam coverage, the operation mode may be identified as the RIS mode.

Methods according to the claims of the disclosure or the embodiments described in the specification may be implemented in hardware, software, or a combination of hardware and software.

In case that implemented in software, a computer-readable storage medium or computer program product storing one or more programs (software modules) may be provided. The one or more programs stored in the computer-readable storage medium or computer program product are configured for execution by one or more processors in an electronic device. The one or more programs may include instructions that cause the electronic device to perform the methods in accordance with the claims of the disclosure or the embodiments described in the specification.

The programs (software modules, software) may be stored in a random access memory (RAM), a non-volatile memory including a flash memory, a read only memory (ROM), an electrically erasable programmable ROM (EEPROM), a magnetic disc storage device, a compact disc-ROM (CD-ROM), a digital versatile disc (DVD) or other types of optical storage device, and/or a magnetic cassette. Alternatively, the programs may be stored in a memory including a combination of some or all of them. Each of the memories may be provided in the plural.

The program may also be stored in an attachable storage device that may be accessed over a communication network including the Internet, an intranet, a local area network (LAN), a wide LAN (WLAN), or a storage area network (SAN), or a combination thereof. The storage device may be connected to an apparatus performing the embodiments of the disclosure through an external port. Also, a separate storage on the communication network may access the device that performs the embodiment of the disclosure.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a machine-readable storage medium (e.g., a CD-ROM) or distributed directly between two user devices (e.g., smart phones) or online (e.g., downloaded or uploaded). In the case of the online distribution, at least part of the computer program product (e.g., a downloadable app) may be at least temporarily stored or arbitrarily created in a storage medium that may be readable to a device such as a server of the manufacturer, a server of the application store, or a relay server.

In the embodiments of the disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

1. A base station (BS) comprising a near field reflecting intelligent surface (RIS), the BS comprising:
the near field RIS including at least one meta surface which reflects an RIS beam into a target area;
a transceiver; and
a processor,
wherein the processor is configured to
identify an operation mode among a normal mode or an RIS mode based on whether the target area is included in a reflecting beam coverage, and control the transceiver to transmit the RIS beam onto the meta surface based on at least one of a type of the near field RIS, configuration information of the near field RIS or information about the target area, in response to the operation mode being identified as the RIS mode,
wherein a type of the near field RIS is identified as a passive type, an active type or a hybrid type based on a type of the meta surface included in the near field RIS, and
wherein the configuration information of the near field RIS is generated based on the type of the meta surface.

2. The BS of claim 1, wherein,
in case that the type of the near field RIS corresponds to the active type, the near field RIS further includes at least one of a bias line, a control board or a control line for controlling a switch device included on the meta surface.

3. The BS of claim 1, wherein, in case that the type of the near field RIS corresponds to the passive type,
the meta surface included on the near field RIS comprises at least one reflecting area,
the RIS beam corresponds to the at least one reflecting area, and
the configuration information of the near field RIS comprises at least one of at least one reflecting area information or information about a RIS beam corresponding to the target area.

4. The BS of claim 1, wherein, in case that the type of the near field RIS corresponds to the active type,
the meta surface included on the near field RIS comprises at least one active element, and
the configuration information of the near field RIS comprises information about the at least one active element.

5. The BS of claim 1, wherein, in case that a type of the near field RIS corresponds to the passive type, the processor is configured to identify the RIS beam corresponding to the target area based on the configuration information of the near field RIS and the information about the target area.

6. The BS of claim 1, wherein the processor is configured to generate control information for adjusting a reflection direction of the meta surface, based on the configuration information of the near field RIS and the information about the target area, in case that a type of the near field RIS corresponds to the active type, and
transmit the control information to the near field RIS through a control line, wherein the RIS beam is reflected by the meta surface into the target area based on the control information.

7. The BS of claim 1, wherein, in case that the type of the near field RIS corresponds to the hybrid type,
the near field RIS comprises a first section including at least one reflecting area and a second section including at least one active element, and
the configuration information of the near field RIS comprises at least one of information about a first section RIS beam corresponding to the first section, information about the at least one reflecting area included in the first section, information about a second section RIS beam corresponding to the second section or information about the at least one active element included in the second section.

8. The BS of claim 1, wherein the processor is configured to,
identify the operation mode as the normal mode, in case that the target area is identified as being in beam coverage, and
in response to the operation mode identified as the normal mode, transmit the coverage beam to the target area included in the beam coverage, wherein the beam coverage corresponds to an area except for the reflecting beam coverage, and the reflecting beam coverage corresponds to a shadow area,
wherein an antenna gain of the coverage beam corresponds to a value equal to or larger than a reference antenna gain, and
wherein the coverage beam corresponds to a beam directed toward the beam coverage.

9. The BS of claim 1, wherein the processor is configured to,
identify the target area by using at least one of the RIS beam or the coverage beam, and
identify the operation mode as the RIS mode, in case that the target area is identified as being included in the reflecting beam coverage.

10. The BS of claim 1, wherein
the near field RIS is located in a near field area of the BS.

11. A method of operating a base station (BS) including a near field reflecting intelligent surface (RIS) in a wireless communication system, the method comprising:
identifying an operation mode among a normal mode or an RIS mode based on whether a target area is included in reflecting beam coverage; and
transmitting an RIS beam onto a meta surface based on at least one of a type of a near field RIS, configuration information of the near field RIS or information about the target area, in response to the operation mode being identified as the RIS mode,
wherein the near field RIS includes at least one meta surface which reflects the RIS beam to the target area,
wherein a type of the near field RIS is identified as a passive type,
an active type or a hybrid type based on a type of the meta surface included in the near field RIS, and
wherein the configuration information of the near field RIS is generated based on the type of the meta surface.

12. The method of claim 11, wherein,
in case that the type of the near field RIS corresponds to the active type, the near field RIS further includes at least one of a bias line, a control board or a control line for controlling a switch device included on the meta surface.

13. The method of claim 11, wherein, in case that the type of the near field RIS corresponds to the passive type,
the meta surface included on the near field RIS comprises at least one reflecting area,
the RIS beam corresponds to the at least one reflecting area, and
the configuration information of the near field RIS comprises at least one of at least one reflecting area information or information about an RIS beam corresponding to the target area.

14. The method of claim 11, wherein, in case that the type of the near field RIS corresponds to the active type,
the meta surface included on the near field RIS comprises at least one active element, and
the configuration information of the near field RIS comprises information about the at least one active element.

15. The method of claim 11, wherein the transmitting of the RIS beam onto the meta surface comprises identifying the RIS beam corresponding to the target area based on the configuration information of the near field RIS and the information about the target area in case that a type of the near field RIS corresponds to the passive type.
